(19) United States
(12) Patent Application Publication
(10) Pub. No.: US 2012/0317849 A1
(43) Pub. Date: Dec. 20, 2012

(54) DISPLAY CARD AND PACKAGE FILM THEREOF

(75) Inventor: Jung-Hsiu CHEN, Taoyuan County (TW)

(73) Assignee: AniCa Corporation, New Taipei City (TW)

(21) Appl. No.: 13/372,530

(22) Filed: Feb. 14, 2012

(30) Foreign Application Priority Data
Jun. 16, 2011 (TW) 100210929

(51) Int. Cl. G09F 1/00; B32B 3/00

(52) U.S. Cl. 40/124.01; 428/195.1

(57) ABSTRACT

A display card and a package film thereof are provided. The display card comprises a package film, a second protection layer, a pattern and a flexible display device. The package film comprises a first protection layer and a color fixing agent. The first protection layer has a first surface and a second surface opposite to the first surface. The color fixing agent is formed on the first surface of the first protection layer. The pattern through the color fixing agent is attached on the first protection layer. The flexible display device is located between the second surface of the first protection layer and the second protection layer.

This application claims the benefit of Taiwan application Serial No. 100210929, filed Jun. 16, 2011, the subject matter of which is incorporated herein by reference.

### BACKGROUND OF THE INVENTION

1. Field of the Invention

The invention relates in general to a display card and a package film thereof, and more particularly to a display card with pattern and a package film thereof.

2. Description of the Related Art

The conventional display card comprises a display device and a protection layer, which envelopes and protects the display device from being damaged by the atmospheric environment. In general, the protection layer is made from polyvinyl chloride (PVC) which is suitable for pattern printing. Thus, the protection layer may have patterns printed thereon without using any auxiliary materials.

However, PVC is expensive and incurs high pollution to the environment. Thus, PVC is not conformed to the requirements of environmental conservation.

### SUMMARY OF THE INVENTION

The invention is directed to a display card and a package film thereof. The protection layer of the package film is made from an environmental-friendly material which incurs low pollution and is conformed to the requirements of environmental conservation.

According to one embodiment of the present invention, a display card is provided. The display card comprises a package film, a second protection layer, a pattern and a flexible display device. The package film comprises a first protection layer and a color fixing agent. The first protection layer has a first surface and a second surface opposite to the first surface. The color fixing agent is formed on the first surface of the first protection layer. The pattern through the color fixing agent is attached on the first protection layer. The flexible display device is located between the second surface of the first protection layer and the second protection layer.

According to another embodiment of the present invention, a package film is provided. The package film is used for enveloping a flexible display device. The package film comprises a protection layer and a color fixing agent. The protection layer has a first surface and a second surface opposite to the first surface. The color fixing agent is formed on the first surface of the protection layer, such that a pattern is attached on protection layer through the color fixing agent. The flexible display device is disposed on the second surface of the protection layer.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a 3D diagram of a display card according to one embodiment of the invention;

FIG. 2 shows a cross-sectional view along the direction 2-2′ of FIG. 1;

FIG. 3 shows a package film according to one embodiment of the invention.

### DETAILED DESCRIPTION OF THE INVENTION

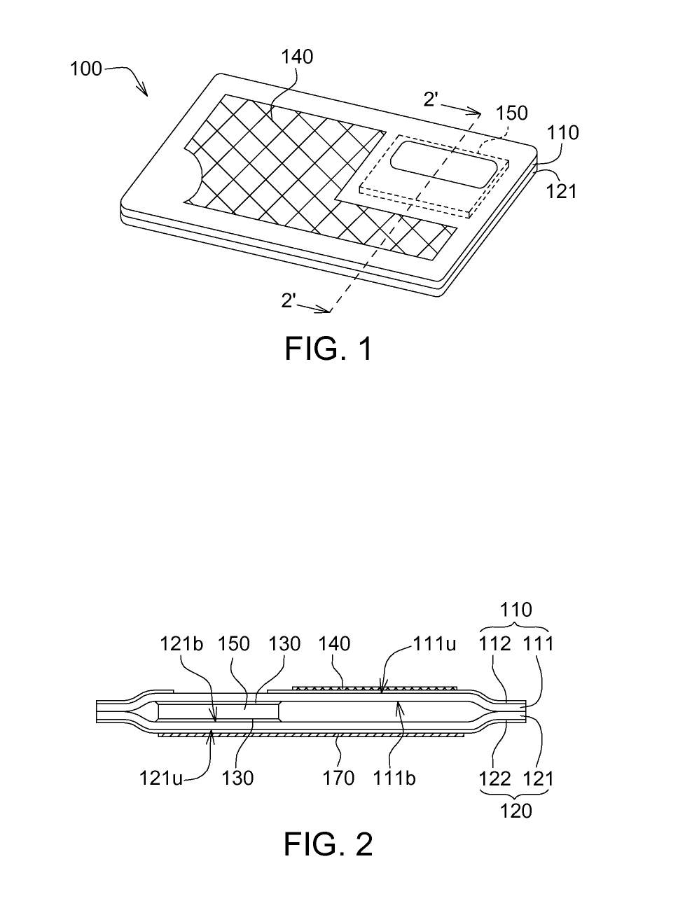

Referring to FIGS. 1 and 2. FIG. 1 shows a 3D diagram of a display card according to one embodiment of the invention. FIG. 2 shows a cross-sectional view along the direction 2-2′ of FIG. 1.

As indicated in FIG. 1, the display card 100 comprises a first package film 110, a second protection layer 121, a first pattern 140 and a flexible display device 150. The first package film 110 comprises a first protection layer 111 and a first color fixing agent 112 (illustrated in FIG. 2). Since the first package film 110, the second protection layer 121 and the flexible display device 150 have flexibility, the display card 100 may be realized as a flexible display card.

The display card 100 may be used in such as prepaid card, password generation card, transport card, membership card, VIP card, access card, electronic key, passport, ID card, label, financial card, credit card, advertising card, entertainment card, name card, PC card, card-type computer, card-type e-book, card-type game machine or physiological signal detection card. The prepaid card is such as an electronic wallet, point card, a transport prepaid card, a telephone card or a cash card. The transport card is such as a transport prepaid card, transport par value card or ticket. The label is such as a price label or a security label.

As indicated in FIG. 2, the first protection layer 111 has a first surface 111u and a second surface 111b opposite to the first surface 111u. The first color fixing agent 112 is formed on the first surface 111u of the first protection layer 111. The first pattern 140 is formed on the first color fixing agent 112. The flexible display device 150 is located between the second surface 111b of the first protection layer 111 and the second protection layer 121.

The first pattern 140 is such as formed on the first protection layer 111 by color particles through printing. The first pattern 140 may be firmly attached on the first protection layer 111 through the first color fixing agent 112. To put it in greater details, under the circumstance that the first pattern 140 is difficult to be directly attached on the first protection layer 111, the first pattern 140 may be firmly attached on the first protection layer 111 through the first color fixing agent 112. The first color fixing agent 112 may assist the first pattern 140 to be firmly attached on the first protection layer 111.

Preferably but not restrictively, the color of the first color fixing agent 112 is white, such that after the first pattern 140 is formed on the first color fixing agent 112, the original color of the first pattern 140 is maintained, and the color of the first pattern 140 will not mix with that of the first color fixing agent 112 to form a distorted color.

The first protection layer 111 and the second protection layer 121 are such as made from a full transparent material or a partly transparent material, so that the display content of the flexible display device 150 may be viewed through the first protection layer 111.

The softening temperatures of the first protection layer 111 and the second protection layer 121 are higher than the melting point of the first color fixing agent 112, wherein the softening temperature refers to such as glass transition temperature (Tg), heat deflection temperature or melting point. In an embodiment, the first protection layer 111 and the second protection layer 121 may be made from resin such as polyethylene terephthalate (PET). The PET melting point is about 256° C. The first color fixing agent 112 is made from such as ink, and the melting point ranges from 70 to 130° C. In comparison to the softening temperatures of the first protection layer 111 and the second protection layer 121, the first color fixing agent 112 is a color fixing agent with low melting point such as an ink with low melting point. In the process of printing patterns of the display card 100, the first color fixing agent 112 with low melting point may become flowing or fluid when the printer is in a low printing temperature, so that the first pattern 140 may be firmly attached on the first color fixing agent 112.

Since the material cost of PET is cheap (in comparison to PVC), the manufacturing cost of the display card 100 may be reduced if the first protection layer 111 and the second protection layer 121 are both made from PET. The PET protection layer is less harmful to the environment (in comparison to PVC), so that the display card 100 is more conformed to the trend of environmental conservation.

The printing method of the first pattern 140 of the display card 100 may adopt large-scale production or small-scale production. Suppose the small-scale production is adopted. The first pattern 140 of the display card 100 may be implemented by a one-card printer. Thus, the design of the first pattern 140 of the display card 100 may be customized or individualized. Since the material cost of PET is cheap, despite the printing method of the first pattern 140 adopts small-scale production (such as using a one-card printer), the manufacturing cost of the display card 100 will not increase and may even be decreased. The one-card printer is realized by such as a display card printer which prints only one copy or a few copies at a time (according to small-scale production).

When printing the first pattern 140, the one-card printer may at the same time seal the first protection layer 111 and the second protection layer 121, such that the edge of the first protection layer 111 and the edge of the second protection layer 121 are tightly bonded and the flexible display device 150 is sealed. Besides, the melting point of the first color fixing agent 112 may correspond to or approach the printing temperature of the one-card printer, such that under the printing temperature of the one-card printer, the first color fixing agent 112 becomes flowing or liquid and makes the first pattern 140 attached on the first color fixing agent 112.

As indicated in FIG. 2, the display card 100 further comprises a second package film 120, while the second package film 120 comprises a second protection layer 121 and a second color fixing agent 122. The second protection layer 121 has a first surface 121u and a second surface 121b opposite to the first surface 121u, wherein the second color fixing agent 122 may be formed on the first surface 121u of the second protection layer 121. The display card 100 further comprises a second pattern 170 formed on the second color fixing agent 122. The second pattern 170 is firmly attached on the second protection layer 121 through the second color fixing agent 122. The flexible display device 150 is located between the second surface 111b of the first protection layer 111 and the second surface 121b of the second protection layer 121.

The characteristics of the materials of the second color fixing agent 122 and the second protection layer 121 are similar to that of the first color fixing agent 112 and the first protection layer 111, and the similarities are not repeated here.

In an embodiment, the display card 100 may omit the second protection layer 121, the second color fixing agent 122 and the second pattern 170.

Besides, the flexible display device 150 is disposed between the first package film 110 and the second package film 120 through the adhesive 130 such as liquid glue.

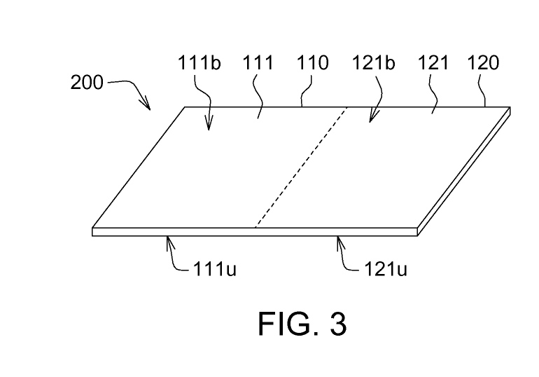

Referring to FIG. 3, a package film according to one embodiment of the invention is shown. The package film 200 comprises at least one first package film 110 and at least one second package film 120, wherein the first package film 110 and the second package film 120 are adjacent to each other. The adhesive 130 (illustrated in FIG. 2) may be coated on the second surface 111b of the first protection layer 111 of the first package film 110 and the second surface 121b of the second protection layer 121 of the second package film 120. Then, the flexible display device 150 is placed on the adhesive 130. Then, the second package film 120 adjacent to the first package film 110 is deflected. Since the first package film 110 and the second package film 120 are adjacent to each other, the flexible display device 150 will be located between the first package film 110 and the second package film 120 after the second package film 120 is deflected. Then, the first package film 110, the second package film 120 and the flexible display device 150 are together fed to a printer (such as a printing equipment used for large-scale production or a one-card printer used for small-scale production) and concurrently print the first pattern 140 and the second pattern 170 and seal the first protection layer 111 and the second protection layer 121 to form the display card 100 of FIG. 1. In an embodiment, after the first protection layer 111 and the second protection layer 121 are sealed, the two protection layers may further be trimmed.

According to the display card and the package film thereof disclosed in the above embodiments of the invention, the protection layer of the package film is made from a material which incurs low pollution to the environment and is conformed to the requirements of environmental conservation. Under the circumstance that the pattern is difficult to be directly attached on the protection layer, the pattern may be firmly attached on the protection layer through the color fixing agent.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display card, comprising:
a first package film, comprising:
a first protection layer, having a first surface and a second surface opposite to the first surface; and
a first color fixing agent formed on the first surface of the first protection layer;
a second protection layer;
a first pattern attached on the first protection layer through the first color fixing agent; and
a flexible display device located between the second surface of the first protection layer and the second protection layer.

2. The display card according to claim 1, wherein the first color fixing agent is made from ink.

3. The display card according to claim 1, further comprising:
a second package film, comprising the second protection layer and a second color fixing agent, wherein the second protection layer has a first surface and a second surface opposite to the first surface, and the second color fixing agent is formed on the first surface of the second protection layer;
the display card further comprises:
a second pattern attached on the second protection layer through the second color fixing agent;
wherein, the flexible display device is located between the second surface of the first protection layer and the second surface of the second protection layer.

4. The display card according to claim 3, wherein the second color fixing agent and the first color fixing agent are made from the same material.

5. The display card according to claim 1, wherein the color of the first color fixing agent is white.

6. The display card according to claim 1, wherein a softening temperatures of the first protection layer and the second protection layer are higher than the melting point of the first color fixing agent.

7. The display card according to claim 1, wherein the melting point of the first color fixing agent corresponds to a printing temperature of a one-card printer, such that under the printing temperature of the one-card printer, the first color fixing agent becomes flowing and makes the first pattern attached on the first color fixing agent.

8. The display card according to claim 1, wherein the first protection layer and the second protection layer are made from a transparent material.

9. The display card according to claim 1, wherein the first protection layer and the second protection layer are made from polyethylene terephthalate (PET).

10. The display card according to claim 1, wherein the melting point of the first color fixing agent ranges from 70 to 130° C.

11. A package film used for enveloping a flexible display device, wherein the package film comprises:
a protection layer, having a first surface and a second surface opposite to the first surface; and
a color fixing agent formed on the first surface of the protection layer, such that a pattern is attached on the protection layer through the color fixing agent;
wherein, the flexible display device is disposed on the second surface of the protection layer.

12. The package film according to claim 11, wherein the color fixing agent is made from ink.

13. The package film according to claim 11, wherein the color of the color fixing agent is white.

14. The package film according to claim 11, wherein a softening temperature of the protection layer is higher than the melting point of the color fixing agent.

15. The package film according to claim 11, wherein the melting point of the color fixing agent corresponds to a printing temperature of a one-card printer, such that under the printing temperature of the one-card printer, the color fixing agent becomes flowing and makes the pattern attached on the first color fixing agent.

16. The package film according to claim 11, wherein the protection layer is made from a transparent material.

17. The package film according to claim 11, wherein the protection layer is made from PET.

18. The package film according to claim 11, wherein the melting point of the color fixing agent ranges from 70 to 130° C.
